(19) United States
(12) Patent Application Publication
(10) Pub. No.: US 2026/0266546 A1
(43) Pub. Date: Sep. 10, 2026

(54) APPARATUS AND METHOD FOR REDUCING THE WATER CONTENT IN VEGETAL OR ANIMAL INORGANIC AND/OR ORGANIC COMPOUNDS

(71) Applicant: WEALTH & RESEARCH TRADING LTD., TA'XBIEX (MT)

(72) Inventors: SONIA DE BORTOLI GAZZUOLA, TA'XBIEX (MT); VITTORIO COGO, TA'XBIEX (MT)

(21) Appl. No.: 18/876,250

(22) PCT Filed: Jul. 11, 2023
(86) PCT No.: PCT/IB2023/057103

§ 371 Date: Dec. 18, 2024

(30) Foreign Application Priority Data
Jul. 11, 2022 (IT) 102022000014539

(51) Int. Cl. F26B 23/04; A23B 7/02; A23L 13/00; F26B 21/30; F26B 25/16

(52) U.S. Cl. CPC F26B 23/04; F26B 21/30; F26B 25/16; A23B 7/0205; A23L 13/00

(57) ABSTRACT

The present invention relates in general to an apparatus and a method for reducing the water content of inorganic and/or organic products or compounds of plant or animal origin, in particular to an apparatus and a method for removing most of the water present in a product or compound of plant or animal origin so as to facilitate its preservation, even over long periods, without undesirable fermentation and significant alteration of the nutritional and organoleptic properties of organic compounds, and prepare the inorganic compounds or products to be used in other processing or obtain finished products.

### FIELD OF INVENTION

The present invention relates in general to an apparatus and a method for reducing the water content of inorganic and/or organic products or compounds of plant or animal origin, in particular to an apparatus and a method for removing most of the water present in a product or compound of plant or animal origin so as to facilitate its preservation, even over long periods, without undesirable fermentation and significant alteration of the nutritional and organoleptic properties of organic compounds, and prepare the inorganic compounds or products to be used in other processing or obtain finished products.

### PRIOR ART

In the state of the art, two main processes are known to reduce the water content of an inorganic and/or organic product or compound of plant or animal origin: drying and lyophilization.

Drying is a heat treatment of an inorganic and/or organic product or compound of plant or animal origin, solid or liquid, in order to remove almost all of the water it contains, from a water content between 35% and 95% to a water content between 2% and 15%.

Drying can be done by artificial methods, which involve the use of apparatus or facilities called dryers, which comprise artificially heated and ventilated environments in which the inorganic and/or organic compounds to be treated are circulated or stands.

Industrial processes for producing dried inorganic and/or organic compounds involve heat treatment involving the transfer of heat from the heating source to the product by convection, thermal conduction, radiation, and the transfer of water from the product to the outside.

To optimize the transfer of water from the product to the outside, it is necessary to calibrate the heat treatment according to how the water is transferred from the product or compound to the outside.

Initially, the water rapidly migrates from the innermost to the outermost layers of the product or compound through the porosities of the product or compound and and once it has reached the surface, it evaporates. At a later stage, as the larger channels dry out, the residual water slowly diffuses outward through the microporosities of the product or compound until the latter reaches a thermo-hygrometric equilibrium with the surrounding environment.

From a technological point of view, this implies that the first phase can occur very rapidly with a sharp rise in temperature.

Known artificial drying methods mainly include: hot air drying, drying by radiation, and drying by direct contact of the product or compound with a heated surface.

Drying by infrared radiation involves irradiating the product or compound by means of a radiation source in the infrared spectrum or with electromagnetic waves in the range of low-frequency electromagnetic waves or high-frequency electromagnetic waves.

Drying by a radiation source in the infrared spectrum or with electromagnetic waves in the low-frequency electromagnetic wave range or high-frequency electromagnetic waves by known methods, however, brings some disadvantages due to the fact that inorganic and/or organic compounds may have a non-uniform composition and conformation.

For example, in high-frequency electromagnetic waves, there is an uneven distribution of heat and energy delivered to the product because this type of electromagnetic wave propagates unevenly in space. This results in non-uniform absorption of the radiation by the organic or inorganic compound, and thus there is non-uniform heating of the inorganic or organic product or compound of plant or animal origin.

In contrast, at low frequencies, electromagnetic waves striking the material allow uniform heat distribution by the water in the material, but change the impedance of the material. Therefore, it is difficult to select an optimal frequency value for the entire duration of the drying or dehydration operation of the compound, and after a certain time interval of operation of the apparatus, there is a decrease in the drying yield.

With these two methods, moreover, having to use mild ventilation apt to remove the extracted water, one must still use high drying temperatures (above 70° C.), with which there is a high degradation of the vitamins in the product, resulting in a decrease in nutritional power.

U.S. Pat. No. 4,999,925 A illustrates an apparatus for heat treatment of a bale of cotton flocks containing moisture and contaminated with honeydew, including means to generate an electromagnetic field with an industrial frequency of 27.12 MHz±0.6% or, in rare cases 13.56 MHz±0.05%. Such an electromagnetic field is used to heat the bale of cotton flocks so as to reduce its moisture content and thus its stickiness.

WO 2020/254977 A1 shows an apparatus for the production of dry pasta, in which the pasta inside the first drying tunnel, in which a vacuum is maintained, is subjected to an electromagnetic field oscillating at a frequency between about 10 MHz and about 100 MHz. As the paste passes through the electromagnetic field between the pairs of electrodes, it is heated. The power applied to the electrodes to generate the oscillating magnetic field is adjusted so that the paste is heated to a temperature between 40° C. and 55° C.

One purpose of the present invention is to provide an apparatus and a method for reducing the water content of an inorganic and/or organic product or compound of plant or animal origin that makes it possible to reduce the time required for drying such products, without, on the one hand, alterations in the structural properties for inorganic compounds, such as weakening of the structure, or, on the other hand, alterations in the dried organic products of plant or animal origin such as degradation of vitamins, alteration of proteins and carbohydrates, and more generally alterations in the chemical-physical, nutritional and organoleptic characteristics of the treated compounds.

Another purpose of the present invention is to provide an apparatus and a method for reducing the water content of the inorganic and/or organic products or compounds of plant or animal origin that makes it possible the inorganic or organic compound of plant or animal origin to be heated uniformly throughout the mass and throughout the surface being treated.

A further purpose of the present invention is to provide an apparatus and a method for reducing the water content of inorganic and/or organic products or compounds of plant or animal origin that makes it possible the selection of the optimal frequency value for reducing the water content of such compounds or products.

A still further purpose of the present invention is to provide an apparatus and a method for reducing the water content of inorganic and/or organic products or compounds of plant or animal origin, that makes it possible the widest variety of such products to be dried, and which has low operating costs, significantly reduces energy consumption and environmental impact to the point of complete eco-sustainability of the process, and also recovers the extracted water.

### SUMMARY OF THE INVENTION

The purposes of the invention are achieved by an apparatus for reducing the initial water content present in inorganic and/or organic products or compounds of plant or animal origin according to claim 1 and by a method for reducing the initial water content present in inorganic and/or organic products or compounds, of plant or animal origin, according to claim 21.

It should be noted that the expression “reducing the initial water content” generally means a dehydration or drying operation of inorganic and/or organic products or compounds of plant or animal origin.

In particular, inorganic products or compounds may include, but are not limited to, salt, plastics, aggregates, sands. Organic products or compounds of plant or animal origin may include meat, fish, grains, fruits and vegetables, general foodstuffs.

The apparatus according to the invention comprises:
a watertight casing, defining or within which a drying chamber is defined.

Specifically, according to one aspect, the drying chamber is designed to function both as a propagation element for electromagnetic waves with at least one first frequency (f1—high frequency) and as an electrode pair for propagating electromagnetic waves with at least one second frequency (f2—low frequency). Thus, it is made possible to use the drying chamber either for the application of a high-frequency generator individually, a low-frequency generator individually, or both alternately or simultaneously. The apparatus of the invention thus makes it possible to use both types of electromagnetic wave (high and low frequency) with the same propagating element, incorporated in, or mounted on, the drying chamber.

Specifically, according to one aspect, in which the drying chamber is itself contained in a watertight casing, the drying chamber is made of microperforated material.

The apparatus according to the invention also includes means for regulating the pressure value inside said drying chamber in such a way that said pressure value is maintained below the value of atmospheric pressure,

The apparatus according to the invention also includes heating means for heating the inorganic and/or organic compounds in the drying chamber said means include at least a first generator of electromagnetic waves with at least one first frequency and/or at least a second generator of electromagnetic waves with at least a second frequency lower than the first frequency, wherein said generators may contain dedicated software for controlling and managing the electromagnetic wave generation and control parameters.

Said generators may both be present, i.e., there may be both at least a first generator of electromagnetic waves with at least a first frequency and at least a second generator of electromagnetic waves with at least a second frequency lower than the first frequency, or only one of the two may be present, e.g., there may be only the at least a first generator of electromagnetic waves with at least a first frequency, or only the at least a second generator of electromagnetic waves with at least a second frequency lower than the first frequency. When both are present, they may operate individually, alternately, and/or simultaneously.

Said apparatus also includes:
at least one propagation element for the propagation of said electromagnetic waves with said first frequency in said drying chamber, connected to said first generator of electromagnetic waves with said first frequency,
and/or at least one pair of electrodes for the propagation of said electromagnetic waves with said second frequency in said drying chamber, where a first electrode is connected to said second generator of electromagnetic waves with said second frequency and the second electrode is connected to ground.

According to one aspect, said at least one propagation element and/or said at least one pair of electrodes is incorporated into and/or mounted on the drying chamber.

Advantageously, the apparatus according to the invention allows inorganic compounds to be dried by heating them to temperatures that do not cause structural damage or inappropriate chemical reactions.

Advantageously, the apparatus according to the invention makes it possible to dry organic compounds or products, preferably foodstuffs, by heating them at sufficiently low temperatures so as not to cause degradation of vitamins and alteration of proteins and carbohydrates contained in the organic compounds, thus maintaining substantially unaltered nutritional, organoleptic or structural properties of the dried organic products or compounds of plant or animal origin.

Due to the combined action of pressure change and the action of an electromagnetic field, the heating of inorganic and/or organic products or compounds of plant or animal origin occurs rapidly and uniformly without the formation of thermal gradients within the compounds, resulting in better and faster elimination of the water they contain.

Advantageously, the presence of one and/or two or more generators makes it possible to select and exploit the most suitable type of electromagnetic wave, even dynamically, during the compound dehydration or drying operation: for example, the lower frequencies, generated by the second electromagnetic wave generator, are suitable for having a better and more uniform distribution of the power delivered by the generator, suitable, for example, for heating products with uniform thickness, e.g., powdered or grain materials, such as salt, grains, or powdered food compounds, while the higher frequencies, generated by the first electromagnetic wave generator, are suitable for obtaining a higher heating capacity even on products with non-uniform thickness, e.g., fruits and vegetables.

Advantageously, as will become clearer from the description of the method according to the invention, one, two or more generators can be installed and used individually, alternately or simultaneously. This allows organic and/or inorganic compounds to be heated with different frequency bands, selected according to the material.

According to one aspect, pressure regulating means are operated to adjust the pressure value within said drying chamber in such a way that the pressure is maintained at a constant value during the drying operation, or in such a way that the pressure has a variable value between at least a minimum pressure value and at least a maximum pressure value during the duration of the drying operation.

Advantageously, the means of pressure regulation can thus be operated in two different modes to maintain a constant or variable pressure value. The operating mode can be selected depending on the product to be dried and dielectric properties thereof.

According to one aspect, the dimensions of said drying chamber are defined as a function of the wavelength of electromagnetic waves generated by said generators according to a mathematical relationship.

According to one aspect, the dimensions of the drying chamber are defined according to the type of one or more electromagnetic wave generators of the heating media.

According to one aspect, the dimensions of the drying chamber, in case it is of parallelepiped shape, are preferably between 43 mm per side and 4000 mm per side, preferably between 200 mm and 4000 mm, or with sides of different size, identified, however, within the range between 43 mm and 4000 mm, preferably between 200 mm and 4000 mm. The same size ranges apply, with reference to diameter, even if the drying chamber is cylindrical in shape.

Advantageously, according to this aspect, the geometry of the drying chamber is selected so as to achieve perfect resonance of electromagnetic waves in the space containing the product.

According to one aspect, wherein the drying chamber is made of microperforated material, the confinement of electromagnetic waves is allowed through the sizing of microholes, for example and not exhaustively the size of microholes for drying, in the case of frequencies from 2400 MHz to 2500 MHz may be 1 mm with vacuum/full ratio of 50%

Specifically, after selecting the optimal frequencies to be used, depending on the dielectric characteristics of the product to be heated, the corresponding wavelength of the electromagnetic radiation that will be generated in the drying chamber is determined. Depending on this wavelength, the sizing of the drying chamber is determined, such that a perfect resonance of the electromagnetic waves in the space containing the product is achieved.

According to one aspect, the apparatus includes a plurality of propagation elements for propagating electromagnetic waves with said first frequency in said drying chamber, arranged on at least one surface of said drying chamber.

According to a variant, said plurality of propagation elements may include a first and a second set of propagation elements.

For example, propagating elements may be arranged at said surface of said drying chamber according to a pattern that comprises a first set of propagating elements, and a second set of propagating elements, and wherein said first and said second sets of propagating elements are parallel to each other, and the propagating elements of said second set are placed at a different height, that is, in a staggered (non-specular) position from the propagating elements of said first set.

According to one aspect, said first set of propagating elements is arranged along a first surface of said drying chamber and said second set of propagating elements is arranged along a second surface of said drying chamber, said second surface being opposite to said first surface.

According to a variant, said plurality of propagation elements may include a single set of propagation elements arranged along the same surface of the drying chamber.

Advantageously, the arrangement of the propagating elements is determined following the choice of the sizing of the drying chamber according to the wavelengths of the electromagnetic waves to be generated.

Advantageously, the presence of a plurality of propagation elements allows more power to be generated in a shorter period of time.

According to one aspect, the means of pressure regulation include at least one regulating valve suitable for delivering air from the environment to the interior of said drying chamber, and at least one vacuum pump suitable for drawing fluids from said drying chamber to the exterior environment to put it under vacuum.

Advantageously, the synergistic action of a control valve and a vacuum pump makes it possible to realize a pressure inside the drying chamber that assumes a variable value while the apparatus is in use.

According to one aspect, the first generator of electromagnetic waves with said at least a first frequency includes a generator of high-frequency electromagnetic waves with a frequency between 900 MHz and 3000 MHz, preferably between 915 MHz and 3000 MHz.

Advantageously, such a frequency range is suitable for achieving higher heating capacity on inorganic and organic compounds of uneven thickness, such as fruits and vegetables.

According to one aspect, the second generator of electromagnetic waves with said second frequency includes a generator of low-frequency electromagnetic waves with a frequency between 10 MHz and 920 Mhz, preferably between 10 MHz and 914 MHz.

Advantageously, such a frequency range is suitable for having a better and more even distribution of the power delivered by the generator suitable, for example, for heating products with uniform thickness, e.g., powdered or grain materials, such as salt, grains, or powdered food compounds.

According to one aspect, the apparatus includes a logical control unit, connected to at least said means of pressure regulation and at least said electromagnetic wave generators.

According to a further aspect, the second ground-connected electrode comprises the surface of said drying chamber.

According to one aspect, the apparatus includes a first filter to prevent the passage of electromagnetic waves having a frequency lower than said first frequency, from said drying chamber to said first generator of electromagnetic waves with said first frequency, and a second filter to prevent the passage of electromagnetic waves having a frequency higher than said second frequency, from said drying chamber to said second generator of electromagnetic waves with said second frequency.

According to one aspect, the at least one propagation element for propagating said electromagnetic waves with said first frequency in said drying chamber includes a waveguide and/or a connector/antenna system.

According to one aspect, the drying chamber includes at least one support element for the product to be dried or dehydrated made of a material transparent to electromagnetic waves generated by said electromagnetic wave generators.

The present invention is also directed to a method for reducing the water content present in inorganic and/or organic compounds of plant or animal origin by an apparatus according to any one of claims 1-20, comprising the following steps:
(a) introducing the inorganic and/or organic compounds to be dried into said drying chamber;
(b) heating said inorganic and/or organic compounds to a temperature that causes evaporation of water contained in said inorganic and/or organic compounds;
(c) maintaining said temperature until the amount of water contained in said inorganic and/or organic compounds is reduced to a predetermined value;
(d) extracting the evaporated water from said drying chamber;
(e) extracting the dried inorganic and/or organic compounds from the drying chamber, characterized by the fact that said step (b) of heating inorganic and/or organic compounds comprises the following steps:
(b1) operating the said pressure regulating means to adjust the pressure so that the pressure value inside the said drying chamber is kept below the value of atmospheric pressure throughout the duration of the drying operation;
(b2) operating the said at least one first generator of electromagnetic waves with a first frequency and/or the said at least one second generator of electromagnetic waves with a second frequency, lower than said first frequency, to generate a magnetic field within said drying chamber that invests said inorganic and/or organic compounds,
wherein the pressure value within said drying chamber is selected so that evaporation of water contained in inorganic and/or organic compounds occurs at a drying temperature such that it does not damage nutritional and organoleptic properties of organic compounds, in particular does not damage vitamins and does not degrade proteins and carbohydrates contained in said organic compounds and does not cause structural damage or inappropriate chemical reactions in said inorganic compounds, in particular at a temperature from −40° C. to +99.8° C., and wherein
said first generator of electromagnetic waves with said at least one first frequency generates high-frequency electromagnetic waves with at least a frequency between 900 Mhz and 3000 MHz, preferably between 915 MHz and 3000 MHz, and/or said second generator of electromagnetic waves with said at least one second frequency generates low-frequency electromagnetic waves with at least a frequency between 10 MHz and 920 MHz, preferably between 10 MHz and 914 MHz.

Advantageously, this method allows the first and/or second generator to be installed and/or operated individually, alternately, or simultaneously. In addition, the method allows the means of pressure regulation to be operated simultaneously, or alternately with the first and/or second generator.

In this way, the optimal combination of pressure and frequency parameters for heating organic or inorganic compounds can be selected.

According to one aspect, the at least one first generator of electromagnetic waves with said at least one first frequency and said at least one second generator of electromagnetic waves with said at least one second frequency can also be present individually.

According to one aspect, the at least one first generator of electromagnetic waves with said at least one first frequency and said at least one second generator of electromagnetic wave with said at least one second frequency are operated alternately.

According to one aspect, the at least one first generator of electromagnetic waves with said at least one first frequency and said at least one second generator of electromagnetic waves with said at least one second frequency are operated simultaneously.

According to one aspect, said at least one first and/or said at least one second electromagnetic wave generator are configured, through said dedicated electromagnetic wave generation and control software, to continuously vary the frequency and/or phase shift (i.e., propagation angle) of the electromagnetic waves.

According to one aspect, the pressure value inside said drying chamber is between 0.01 mbar and 999 mbar, preferably between 0.05 mbar and 999 mbar, more preferably between 9 mbar and 100 mbar.

Advantageously, the means of pressure regulation can thus be operated in two different ways to achieve the desired type of drying:
according to one aspect, in fact, in said step (b1) the said means of pressure regulation are operated to maintain the pressure inside said drying chamber at a constant value throughout the drying operation.

According to an alternative aspect, in said step (b1) said means of pressure regulation are operated to vary the pressure within said drying chamber between at least a minimum pressure value and at least a maximum pressure value during the duration of the drying operation.

According to this aspect, the minimum pressure value is about 1 mbar, and said maximum pressure value is about 200 mbar. Preferably, said maximum pressure value is equal to about 50 mbar.

According to one aspect, subsequent to said step (d) of extracting the evaporated water from said drying chamber, it further includes a step of condensing the evaporated water from said inorganic and/or organic compounds by means of a condensate separator element.

According to one aspect, at the end of the drying operation, the percentage of residual water contained in said inorganic and/or organic compounds is between 0% and 40% by weight, preferably between 1% and 20% by weight.

According to one aspect, the method of the present invention enables operation with a plurality of drying chambers arranged in parallel, that is, by a discontinuous process.

According to one aspect, the method of the present invention enables operation with a plurality of drying chambers arranged in series, that is, by a continuous process.

According to a preferred embodiment, the method of the present invention enables operation with at least one drying chamber, preferably a plurality of drying chambers, operated by an automatic system comprising at least one frame, preferably a plurality of movable frames and configured to feed said plurality of drying chambers with the product to be dried and to take the dried product from said plurality of drying chambers. In other words, each frame is adapted to transport within a corresponding drying chamber a certain amount of product to be dried, and once the drying process is completed, to transport outside the drying chamber the dried product.

According to a variant, the automatic system comprising said plurality of moving frames allows operation by a discontinuous process.

According to a preferred variant and alternative to the previous one, the automatic system comprising said plurality of moving frames enables operation by a continuous process.

The present invention is also directed to the use of an apparatus according to any one of claims 1-18 to dry inorganic and/or organic compounds of plant or animal origin.

It should be noted that the present invention allows for minimal environmental impact because there is very low heat dissipation to the environment because the heat for drying the inorganic and/or organic compounds is generated within the inorganic and/or organic compounds themselves and no heat carrier medium is required, and there is also no production of fumes or vapors.

### BRIEF DESCRIPTION OF THE DRAWINGS

These and other aspects of the present invention will be evident from the following detailed description, provided here for illustrative and non-limiting purposes only, with reference to the attached drawings, wherein:

FIG. 1 is a schematic view of an embodiment of an apparatus according to the invention;

FIG. 2 is a perspective view of an embodiment of a drying chamber 2 of an apparatus according to the invention;

FIG. 3A and FIG. 3B are two perspective views, in partial transparency, of an embodiment of a drying chamber 2 of an apparatus according to the invention;

FIG. 4 is a perspective view of an embodiment of an apparatus according to the invention;

FIG. 5 is a perspective view of a further embodiment of an apparatus according to the invention;

FIG. 5A is a perspective view of an embodiment of an apparatus according to the invention, suitable for continuous-cycle industrial-scale production;

FIG. 5B is a perspective view of the apparatus according to the invention shown in FIG. 5A, showing the interior of the apparatus;

FIG. 5C is a schematic view of an embodiment of an apparatus according to the invention, suitable for continuous-cycle industrial-scale production;

FIG. 5D is a schematic view of a further embodiment of an apparatus according to the invention, suitable for continuous-cycle industrial-scale production;

FIG. 6 shows a table with the pressure and temperature values of water vapor.

### DETAILED DESCRIPTION OF POSSIBLE EMBODIMENTS OF THE INVENTION

With reference to the attached drawings, some possible embodiments of the apparatus according to the present invention will be described.

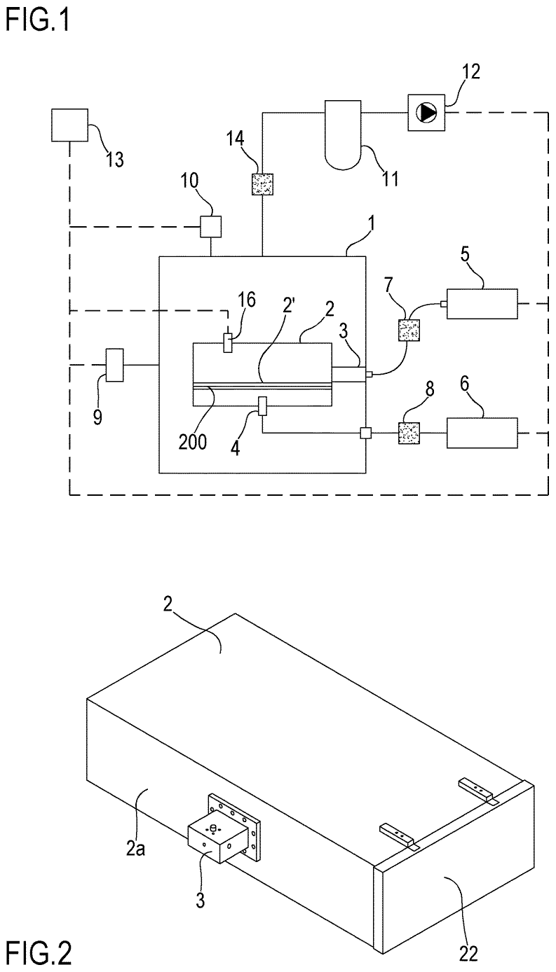

FIG. 1 shows schematically an embodiment of an apparatus according to the invention for drying inorganic and/or organic compounds of plant or animal origin.

The apparatus includes a watertight casing 1, which defines or within which a drying chamber 2 is defined.

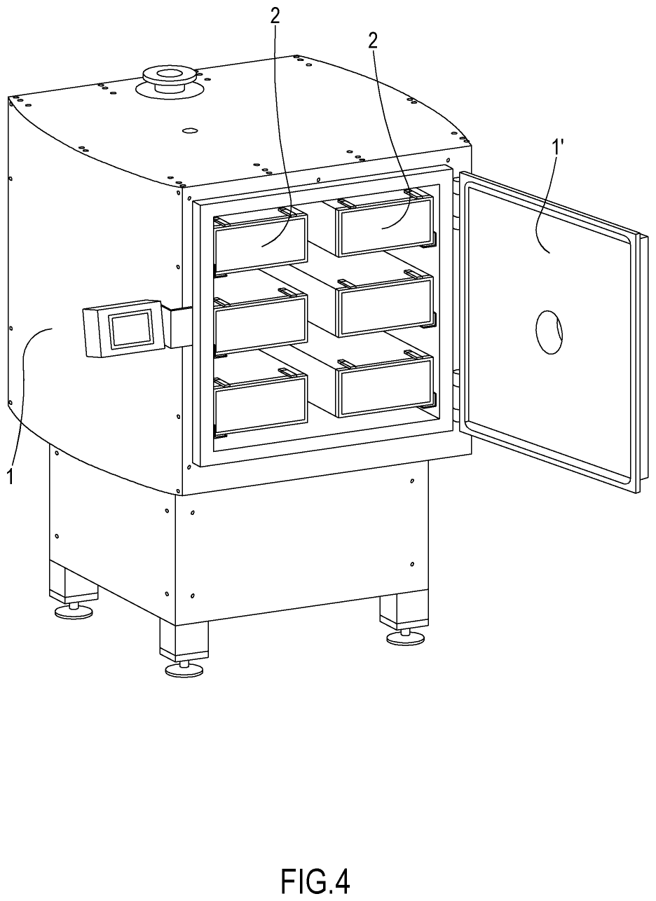

In one embodiment, shown in FIG. 4, the apparatus can include a plurality of drying units 2 operating in parallel, for example, four to twelve, depending on the desired throughput. For example, the apparatus shown in FIG. 4 includes six drying units.

Casing 1 is equipped with door 1′, also watertight, through which the inorganic and/or organic compounds to be dried can be introduced into drying chamber 2, also equipped with door 22, defined within the casing 1.

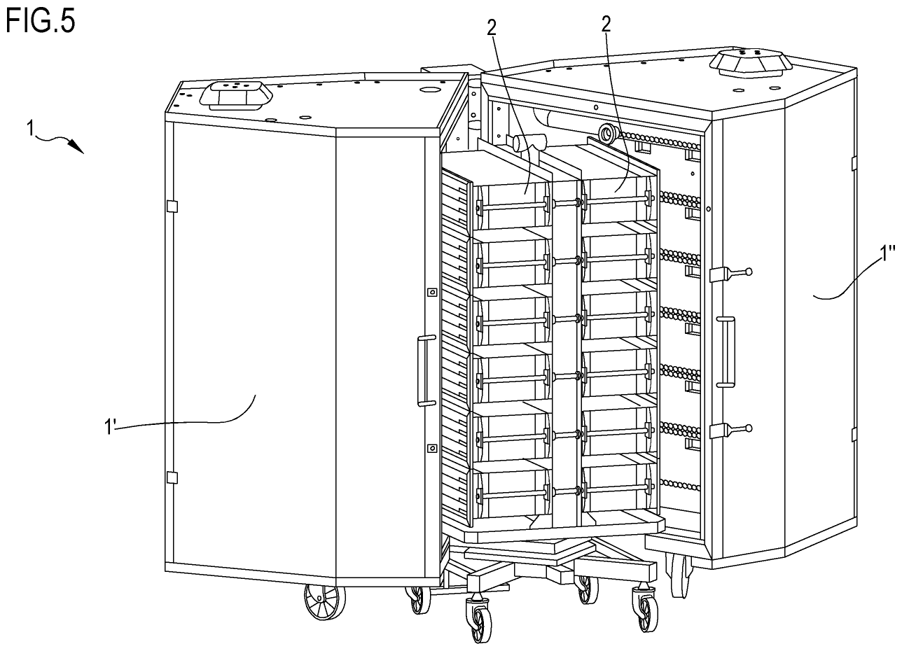

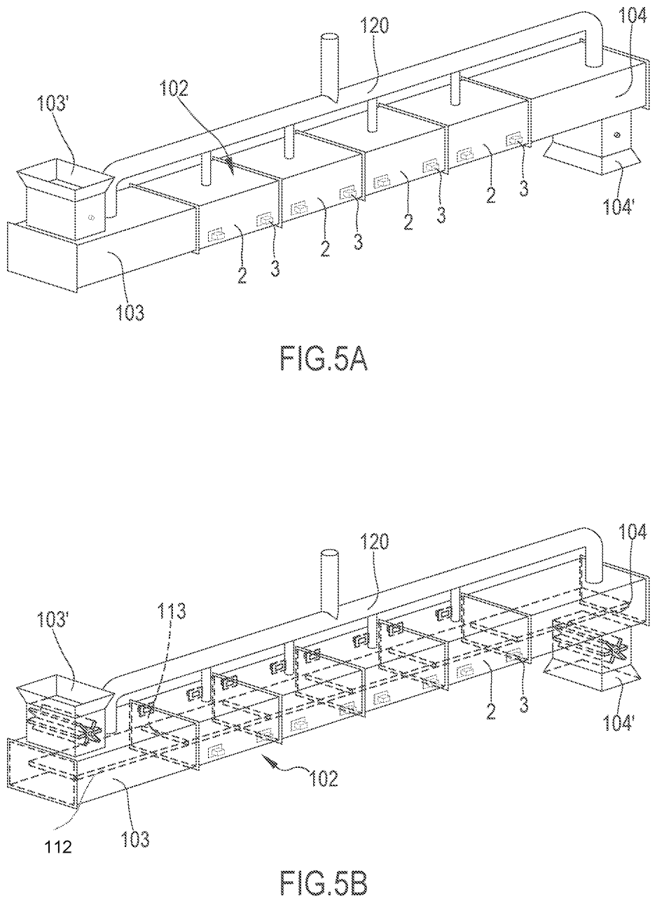

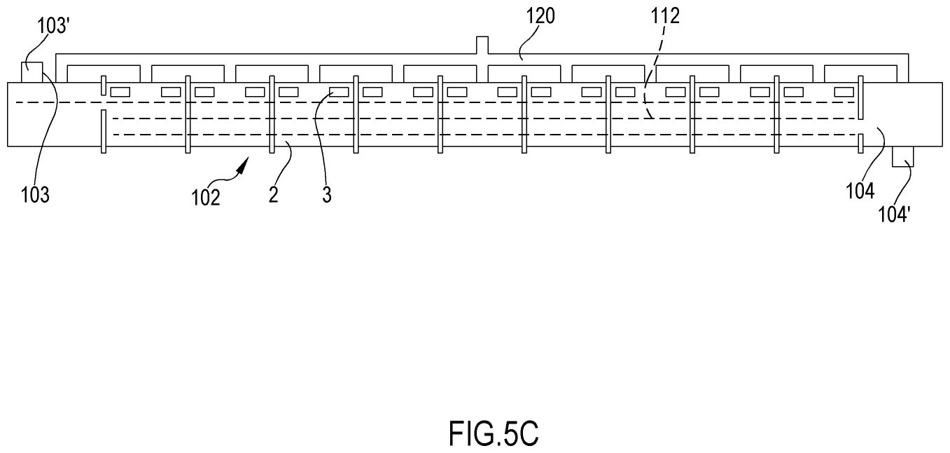

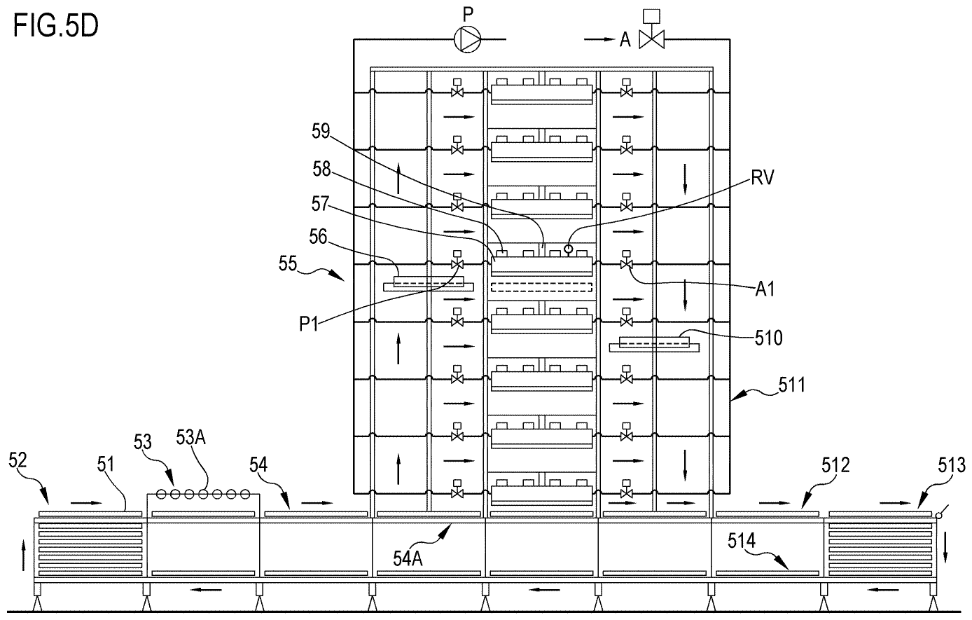

In a further embodiment, shown in FIG. 5, the apparatus may include a plurality of drying chambers 2 operating in parallel, for example, two to twenty, preferably eight to sixteen, depending on the desired throughput. For example, the apparatus shown in FIG. 5 includes twelve drying chambers. In this embodiment, casing 1 is configured to consist of two portions or shells 1′ and 1″ hinged to each other at one end and anchored to the ground by a pillar acting as a pivot and capable, when closed, of providing a watertight seal. Advantageously, in a preferred variant of this embodiment, shown in FIG. 5, the drying chambers are installed on a slide-out trolley with wheels, which engages within the watertight cavity by means of special guides in the cavity to ensure proper positioning. Advantageously, the shells 1′ and 1″ also rest in the front on wheels. This configuration facilitates the opening and closing of the shells 1′ and 1″ and speeds up the introduction and extraction of inorganic and/or organic compounds to be dried, as well as speeding up cleaning operations.

In one embodiment, a support element 2′ is arranged in the drying chamber 2 on which the inorganic and/or organic compounds to be dried are placed.

Attached FIGS. 1, 4 and 5 show embodiments of apparatus that include casing 1 and a parallelepiped-shaped drying chamber, but embodiments in which the casing 1 and associated drying chamber 2 are cubic or cylindrical in shape are not excluded.

The apparatus according to the invention includes means of pressure regulation 9, 10, 12, suitable for regulating the pressure value inside the drying chamber 2 in such a way that the pressure value is kept below the value of atmospheric pressure.

Specifically, as shown in FIG. 1, in one possible embodiment, the means of pressure regulation 9, 10, 12 include at least one vacuum pump 12 adapted to draw fluids from the drying chamber 2 to the outside environment to put it under vacuum, and at least one control valve 9 adapted to deliver air from the environment to the inside of the drying chamber 2 to increase the pressure value inside the drying chamber 2. In addition, the means of pressure regulation may also include a pressure gauge 10, or vacuum gauge, which is used to measure the depression realized in the drying chamber 2 by the vacuum pump 12 during the drying process.

As will be better described below, with respect to the method according to the invention for drying inorganic and/or organic compounds of plant or animal origin, it should be noted that vacuum pump 12 and regulating valve 9 can be used alternately: for example, in the event that the pressure gauge or vacuum gauge 10 detects a lower pressure value than desired, the vacuum pump 12 can be turned off, and the regulating valve 9 can be operated to introduce air at atmospheric pressure inside the drying chamber 2 in order to increase the pressure value inside the chamber.

In this way, the means of pressure regulation 9, 10, 12 can be operated to adjust the pressure value inside the drying chamber 2 in such a way that the pressure is maintained at a constant value during the drying operation, or in such a way that the pressure takes on a variable value, such as between at least one minimum and at least one maximum pressure value during the duration of the drying operation.

In an embodiment, a filter 14 is placed between the drying chamber 2 and the vacuum pump 12 that prevents any residual inorganic and/or organic compounds in the air from reaching the vacuum pump and damaging it.

The apparatus according to the invention further comprises heating means 5 and/or 6 for heating the inorganic and/or organic compounds in the drying chamber 2. Such heating means 5 and/or 6 comprise at least a first generator 5 of electromagnetic waves with at least a first frequency f₁ and/or at least a second generator 6 of electromagnetic waves with at least a second frequency f₂ lower than the first frequency f₁, of the electromagnetic waves emitted by the first generator 5.

Specifically, in a possible embodiment, the first generator 5 of electromagnetic waves with at least a first frequency f₁ includes a generator of high-frequency electromagnetic waves with a frequency f₁ between 900 MHz and 3000 MHz, preferably between 915 MHz and 3000 MHz, while the second generator 6 of electromagnetic waves with at least a second frequency f₂ includes a generator of low-frequency electromagnetic waves with a frequency f₂ between 10 MHz and 920 Mhz, preferably between 10 MHz and 914 MHz.

The first generator 5 is a high-frequency electromagnetic wave generator known in technology, called a solid-state generator.

As will be better described below, with respect to the method for drying inorganic and/or organic compounds of plant or animal origin according to the invention, the first and/or second generators 5 and/or 6 can be installed and operate individually, alternately, or simultaneously, depending on the product or compound and the type of drying to be performed.

This provides an opportunity to take advantage of the most suitable type of electromagnetic wave: e.g. the lower f₂ frequencies, between 10 MHz and 920 Mhz, preferably between 10 MHz and 914 MHz generated by the second generator 6 of electromagnetic waves, are suitable for having a better and more uniform distribution of the power delivered by the generator on products with uniform thickness, such as powdered products or grains, e.g., salt, grains, or powdered food products, while the higher f₁ frequencies, between 900 MHz and 3000 MHz, preferably between 915 MHz and 3000 MHz generated by the first generator 5 of electromagnetic waves are suitable for achieving higher heating capacity even on products with non-uniform thickness.

In this regard, as will become clearer from the description of the method according to the invention, a generator can make a selection of the optimal frequencies by scanning those frequencies with a minimum test power (e.g., 10 watts) by measuring the percentage of power that returns to the generator. This power is not absorbed by the product, so the software eliminates all frequencies that have a return value greater than 10% and will only work with frequencies that have a return power value of less than 10%, preferably 5%.

The apparatus according to the invention includes at least one propagation element 3 for propagating electromagnetic waves with the at least one first frequency f in the drying chamber 2. This propagation element 3 is connected to the first generator 5 of electromagnetic waves with the first frequency f₁.

In particular, the at least one propagation element 3 for propagating electromagnetic waves with the at least one first frequency f₁ in the drying chamber 2, may comprise an electromagnetic wave conveying and confining means known in the art, for example may comprise a waveguide and/or a connector/antenna system. The at least one propagation element 3 is arranged at a surface of the drying chamber 2, and faces inwardly into the drying chamber 2, within which the inorganic and/or organic compounds to be dried are contained.

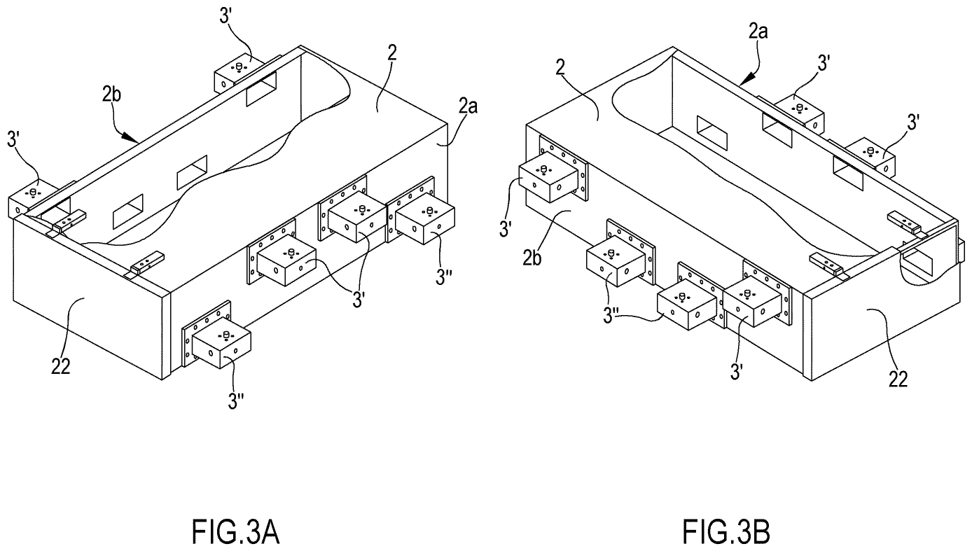

As shown in FIGS. 3A and 3B, as an example but not exhaustive, in one possible embodiment the apparatus includes a plurality of propagation elements 3 for the propagation of electromagnetic waves with the first frequency f₁ in the drying chamber 2, arranged on at least one surface of the drying chamber 2.

Such propagation elements 3 may be arranged at the surface of drying chamber 2 according to a pattern comprising a first set of propagation elements 3′, and a second set of propagation elements 3″, wherein said first and said second sets of propagation elements 3′, 3″ are parallel to each other in the direction of longitudinal development of drying chamber 2, and the propagation elements 3″ of the second set are in a staggered, i.e., non-specular, position with respect to the propagation elements 3′ of the first set.

In other words, the propagation elements 3″ of the second series are placed at a different height, along a direction orthogonal to the direction of longitudinal development of drying chamber 2, than the propagation elements 3′ of the first series.

The number of propagation elements 3 and their placement is also determined according to the power to be delivered by the at least one first generator 5 to heat the organic or inorganic compound.

The power to be delivered is given by the type of compound and its percentage water content, and the time required for it to evaporate to reach the desired residual water content.

In one embodiment, the first generator 5 (not shown in the figure) includes four outputs, connected to four respective propagation elements 3′, 3′, 3″, 3″, generating a total power value of 1 kW.

In one embodiment, not shown in the attached drawings, the apparatus includes a plurality of generators 5 and/or 6. For example, in the case where the power required to heat the compound is 3 kW, three generators 5 can be used, each equipped with four outputs generating a total of 1 kW power.

In the embodiment shown in FIGS. 3A and 3B, the apparatus comprises eight propagation elements 3, specifically eight waveguides, wherein four waveguides are placed on a first side surface 2a of drying chamber 2 (FIG. 3A), and four additional waveguides are placed non-specularly on an additional side surface 2b of drying chamber 2 (FIG. 3B), specifically they are placed on the opposite side surface 2b.

In a variant embodiment not shown in the figures, all waveguides are arranged along one and the same surface, side or otherwise, of the drying chamber.

In more detail, at each side surface 2a, 2b, two waveguides 3′ of a first pair of waveguides are both arranged at the same height and at opposite vertices of the respective side surface 2a, 2b of drying chamber 2, i.e., at a position distal to the transverse axis of the respective surface 2a, 2b of drying chamber 2, while two additional waveguides 3″ of a second pair of waveguides are both arranged at the same height, which is different, however, from that at which the two waveguides 3′ are arranged, in a position proximal to the transverse axis of the respective surface 2a, 2b of drying chamber 2.

In one embodiment, the apparatus includes a first filter 7 to prevent the passage of electromagnetic waves having a frequency lower than the first frequency f₁, from the drying chamber 2 to the first generator 5 of electromagnetic waves with the first frequency f₁.

Specifically, with reference to FIG. 1, the first filter 7 is placed between the first generator 5 of electromagnetic waves with the first frequency f₁ and its propagating element 3. Thus, backflows into the first generator 5 of electromagnetic waves with the first frequency f₁ are prevented.

The apparatus according to the invention may further comprise at least one pair of electrodes 4, 2 for propagating the electromagnetic waves generated by the possible second generator 6 with the at least one second frequency f₂ in the drying chamber 2, wherein a first electrode 4 is connected to the second generator 6 of electromagnetic waves with the second frequency f₂ and the second electrode 2 is connected to ground. The first electrode 4 is a positive electrode, and the second electrode 2 is a negative electrode.

In one embodiment, the second ground-connected electrode 2 comprises the actual surface of the drying chamber 2. The first electrode 4 is placed at a surface of the drying chamber 2, and faces inward from the drying chamber 2, within which the inorganic and/or organic compounds to be dried are contained.

In one embodiment the apparatus includes a second filter 8 to prevent the passage of electromagnetic waves having a frequency higher than the second frequency f₂, from the drying chamber 2 to the second generator 6 of electromagnetic waves with the second frequency f₂.

Specifically, with reference to FIG. 1, the second filter 8 is placed between the second generator 6 of electromagnetic waves with the second frequency f₂ and the first electrode 4. Thus, backflows into the second generator 6 of electromagnetic waves with the second frequency f₂ are prevented.

With reference to FIG. 1, the apparatus can be equipped with a control logic unit 13, connected to at least the means of pressure regulation 9, 10, 12, and at least the generators 5 and/or 6 of electromagnetic waves.

As anticipated, the drying chamber may comprise within it at least one support element 2′, which is disposed between a first positive electrode 4, connected to the second generator 6 of electromagnetic waves with the second frequency f₂, suitable for generating an electromagnetic field with a frequency between 10 MHz and 920 Mhz, preferably between 10 MHz and 914 MHz, and a second negative electrode 2 connected to ground. The support element 2′ is made of a material transparent to electromagnetic waves in the frequency band between 10 MHz and 920 Mhz, preferably between 10 MHz and 914 MHz, for example, the support element can be made of POM, PP, PIC, ceramic, glass.

In one embodiment, the support element 2′ is mounted on a load cell system 200, through which the weight loss of the inorganic and/or organic compounds placed on the support element 2′, due to the evaporation of the water in them, can be detected during the drying process.

As anticipated, the present invention is also directed to a method for drying inorganic and/or organic compounds of plant or animal origin, which will be described below.

The method according to the invention includes a step in which the inorganic and/or organic compounds to be dried are introduced into the drying chamber 2, and can be placed on the at least one support element 2′.

Next, the method according to the invention involves a step of heating the inorganic and/or organic compounds to a temperature that causes evaporation of water contained in these inorganic and/or organic compounds.

This temperature is maintained until the amount of water contained in the inorganic and/or organic compounds is reduced to a predetermined value.

This heating step of the inorganic and/or organic compounds is carried out by the synergistic action of the pressure change inside the drying chamber 2, in particular for the depression realized inside the drying chamber 2 by means of the pressure regulating means 9, 10, 12, and the generation of an electromagnetic field inside the drying chamber 2 by at least one of the electromagnetic wave generators 5 and/or 6.

In one possible embodiment, the means of pressure regulation 9, 10, 12, and the generators 5 and/or 6 of electromagnetic waves are controlled and operated through the control logic unit 13.

In particular, the heating step of the inorganic and/or organic compounds is carried out by operating the pressure regulating means 9, 10, 12 to adjust the pressure such that the pressure value inside the drying chamber 2 is maintained below the value of atmospheric pressure throughout the drying operation, and operating at least the first generator 5 of electromagnetic waves with a first frequency f₁ and/or at least the second generator 6 of electromagnetic waves with a second frequency f₂, which is lower than the first frequency f₁, to generate a magnetic field inside the drying chamber 2 that invests the inorganic and/or organic compounds. After introducing the inorganic and/or organic compounds to be dried into the drying chamber 2, the vacuum pump 12 is started until a pressure of a value less than atmospheric pressure is obtained inside the drying chamber 2.

As anticipated above, since, as is well known, the evaporation temperature of water is pressure-dependent and decreases as the pressure decreases, the value of the pressure inside the drying chamber 2 is selected so as to achieve evaporation of water, contained in the inorganic and/or organic compounds to be dried, at a temperature from −40° C. to +99.8° C., preferably between −22° C. and +70° C., more preferably between 5° C. and 45° C.

In one embodiment, the value of pressure inside the drying chamber 2 is selected so as to achieve the evaporation of water, contained in the inorganic and/or organic compounds to be dried, at a temperature that does not damage vitamins and does not degrade proteins and carbohydrates contained in said organic compounds and that does not cause structural damage or inappropriate chemical reactions in said inorganic compounds, particularly at a temperature between 5° C. and 45° C.

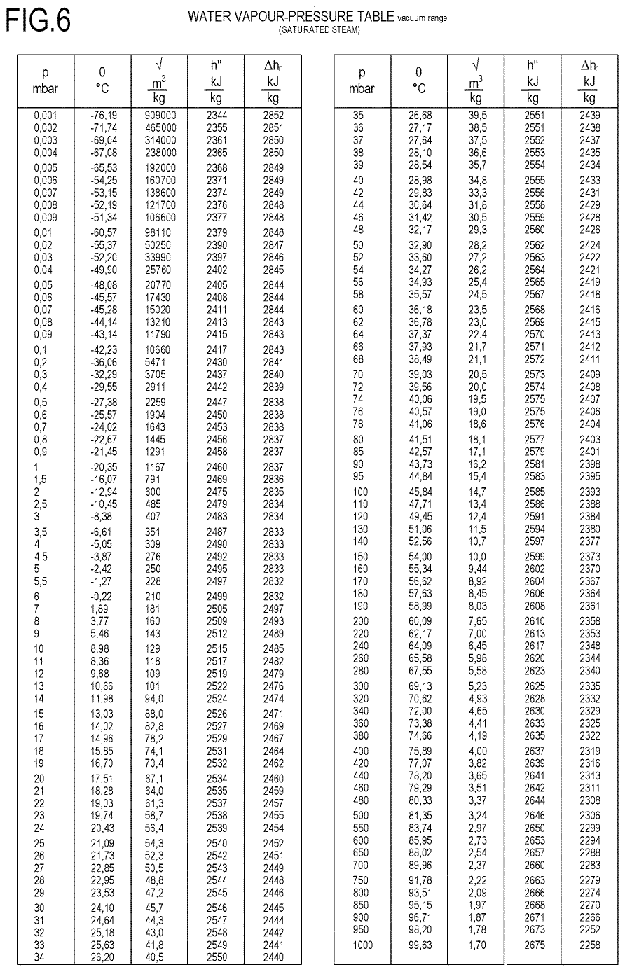

The values of P and T are related by a physical law expressed in the attached table, shown in FIG. 6, which identifies the evaporation temperatures of water as pressure changes. Frequencies are selected across the entire spectrum according to the characteristics of the product to be treated and the yield on the identified working volume. The frequencies of the electromagnetic waves are totally unrelated to the choice of drying pressure and temperature.

In a further embodiment, drying can also be carried out at lower temperatures, for example down to even 5° C., by reducing the pressure inside the drying chamber (as above).

In a further embodiment, drying can also be carried out at lower temperatures, for example down to even-40° C., preferably down to −22° C.

In one embodiment, the pressure value inside drying chamber 2 can be between 0.01 mbar and 999 mbar, preferably between 0.05 mbar and 999 mbar, more preferably between 9 mbar and 100 mbar.

In the method according to the invention, the at least one first generator 5 of electromagnetic waves with the at least one first frequency f₁ generates high frequency electromagnetic waves with at least one frequency f₁ between 915 MHz and 3000 MHz, and/or the at least one second generator 6 of electromagnetic waves with the at least one second frequency f₂ generates low frequency electromagnetic waves with at least one frequency f₂ between 10 MHz and 914 MHz.

As anticipated, the two generators 5 and/or 6 can be installed and operated individually, alternately or simultaneously.

After the heating and drying operation of the inorganic and/or organic compounds inside the drying chamber is completed, the method according to the invention includes the step of extracting the evaporated water from the inorganic and/or organic compounds from the drying chamber 2, and then includes the step of extracting the dried inorganic and/or organic compounds from the drying chamber 2.

Pressure adjustment means 9, 10, 12 can be operated in two different ways,

According to a first mode M_{P1} the pressure control means 9, 10, 12 are operated to keep the pressure inside the drying chamber 2 at a constant value throughout the drying operation.

According to a second to mode M_{P2} the pressure control means 9, 10, 12 are operated to vary the pressure inside the drying chamber 2 between at least a minimum pressure value and at least a maximum pressure value during the duration of the drying operation. Preferably, the minimum pressure value is about 1 mbar, and the maximum pressure value is about 200 mbar, preferably the maximum pressure value is about 50 mbar.

The apparatus according to the invention can operate in four different modes.

### Mode 1:

In this mode of operation, the pressure control means 9, 10, 12 are operated according to the above-described mode M_{P1} to maintain the pressure inside drying chamber 2 at a constant value throughout the drying operation.

Depending on the product or compound to be dried and the type of drying desired, the optimum pressure value, and the optimum frequencies for performing the heating and drying operation are selected.

In one embodiment, the selection of optimal frequencies is made by scanning the product or compound to be dried, operated by generators 5 and/or 6, which detects which frequency develops the highest yield based on the percentage of reflected power, as previously described.

In a further embodiment, such selection can be made by the control unit 13 in which drying recipes for different types of inorganic and/or organic compounds can be stored.

Once optimal pressure and frequency values are defined, pressure control means 9, 10,12 are operated to maintain the selected pressure value within the drying chamber and the first and/or second electromagnetic wave generator 5 and/or 6 are operated to generate an electromagnetic wave with the selected optimal frequency value, which will be maintained throughout the drying process.

According to this first mode, the inorganic and/or organic compounds are heated by means of the electromagnetic wave generated by at least one of the electromagnetic wave generators 5 and/or 6 to the evaporation temperature of water at a predetermined pressure inside the drying chamber 2. Specifically, pump 12 is started until the predetermined pressure is reached inside the drying chamber 2, so that the evaporation of the water contained in the inorganic and/or organic compounds begins. Evaporation ends when a desired residual moisture content in the inorganic and/or organic compounds is reached.

Mode 1 therefore operates using a constant vacuum value and constant frequency.

### Mode 2:

In this mode of operation, the pressure regulating means 9, 10, 12 are operated according to the above-described mode M_{P1} to maintain the pressure inside drying chamber 2 at a constant value throughout the drying operation.

Depending on the product or compound to be dried and the type of drying desired, the optimum pressure value, and the optimum frequencies for performing the heating and drying operation are selected.

In one embodiment, the selection of optimal frequencies is made by scanning the product or compound to be dried, operated by generators 5 and/or 6, which scans the electromagnetic waves and selects the frequencies that produce a yield greater than 90%, preferably greater than 95%, even more preferably greater than 98%. Said generators 5 and/or 6 sequentially emit a series of sample signals and select the signals that produce a signal return of less than 10%.

In one embodiment of such a second mode, once the scanning is finished, at least one generator 5 and/or 6, to be chosen by the operator according to the product to be dried, begins to deliver power, varying the frequency of the generated electromagnetic wave by selecting from time to time a frequency value from those previously selected, which allow a minimum yield of 90%, at predetermined intervals that are settable, for example, from a control and command panel present in the apparatus.

As an example, if the product has an irregular shape the high-frequency generator will be installed and activated, and/or if the product has a regular shape the low-frequency generator will be installed and activated.

As an example, the generated frequencies can be varied at selected time intervals between 1 and 300 seconds, preferably between 10 and 200 seconds, more preferably between 20 and 120 seconds.

The at least one generator 5 and/or 6 continues to deliver power for a predefined time interval, which can be set from the control and command panel, after which a new scan of the product or compound is made to determine, based on the newly detected product or compound characteristics (particularly residual weight and percentage of residual water), a new range of optimal frequencies that produce the maximum yield in light of the amount of residual water in the product.

In fact, upon drying the product changes its dielectric properties, so the most effective frequencies for heating it also change accordingly.

Mode 2 therefore operates using a constant vacuum value and variable frequency.

### Mode 3:

In this mode of operation, the pressure control means 9, 10, 12 are operated according to the above-described mode M_{P2} to vary the pressure inside the drying chamber 2 between at least a minimum pressure value and at least a maximum pressure value during the duration of the drying operation.

Preferably, the minimum pressure value is about a 1 mbar and the maximum pressure value is about 999 mbar.

In one embodiment, the pressure value varies between at least a minimum value and at least a maximum value in times that can be set by a control and command panel.

Again, as in mode 2, in one embodiment the selection of optimal frequencies is made by scanning for the best frequencies to use and the frequencies that produce a yield greater than 90%, preferably greater than 95%, even more preferably greater than 98%, are selected.

In one embodiment of such a third mode, once the scanning is finished, at least one generator 5 and/or 6, at the operator's choice according to the product to be dried, starts delivering power, varying the frequency of the generated electromagnetic wave by selecting from time to time a frequency value from those previously selected, which allow a minimum yield of 90%, at predetermined time intervals that are settable, for example, from a control and command panel present in the apparatus.

As an example, the generated frequencies can be varied at selected time intervals between 1 and 300 seconds, preferably between 10 and 200 seconds, more preferably between 20 and 120 seconds.

The at least one generator 5 and/or 6 continues to deliver power for a predefined time interval, which can be set from the control and command panel, after which a new scan of the product or compound is made to determine, based on the newly detected product or compound characteristics (particularly residual weight and percentage of residual water), a new range of optimal frequencies that produce the maximum yield in light of the amount of residual water in the product.

In fact, upon drying the product changes its dielectric properties, so the most effective frequencies for heating it also change accordingly.

Mode 3 therefore operates using pulsing vacuum and variable frequency.

### Mode 4:

In this mode of operation, the pressure control means 9, 10, 12 are operated according to the above-described mode M_{P2} to vary the pressure inside the drying chamber 2 between at least a minimum pressure value and at least a maximum pressure value during the duration of the drying operation.

Preferably, the minimum pressure value is about a 1 mbar and the maximum pressure value is about 999 mbar.

As in modes 2 and 3, the optimal frequency value is varied by successive scans of the product or compound. After the product or compound in the chamber has been heated, the at least one generator 5 and/or 6 is turned off and the pressure control means are operated to bring the pressure inside the drying chamber 2 to a value as close to 0 mbar as possible to evaporate as much water as possible by rapidly decreasing the water evaporation temperature.

Then, after reaching that pressure value near about 0 mbar, the pressure is restored to the starting value ranging from 100 to 999 mbar, and the at least one generator 5 and/or 6 is operated again to heat the product or compound.

The process is repeated until the product reaches the desired moisture content.

Mode 4 therefore operates using pulsing vacuum and variable frequency alternating with each other.

In all four modes described, the inorganic and/or organic compounds to be dried, placed on the support element 2′ inside the drying chamber 2, are invested by the electromagnetic waves generated by at least one generator 5 and/or 6, which causes the water contained within them to heat up to the evaporation temperature of the water at the pressure present inside the drying chamber 2.

The value of the pressure inside drying chamber 2 is selected so that the evaporation temperature of water at that pressure is lower than temperature values that can change the chemical-physical and structural properties of the treated product.

In particular, with regard to organic compounds and products, the temperature is selected within suitable values so as not to damage the vitamins, or degrade the proteins and lipids present, preferably between −40° C. and +70° C., preferably between −22° C. and +70° C., plus preferably between 5° C. and 45° C.

Specifically, with regard to inorganic products and compounds, the temperature is selected within suitable values that do not change the physical chemical structure of the product or compound, therefore preferably between −40° C. and +99.8° C., preferably between −22° C. and +70° C., more preferably between 5° C. and 45° C. Reaching the evaporation temperature of water at the pressure present in drying chamber 2 is detected by temperature sensor 16.

When the evaporation temperature is reached, the process of evaporation of the water present in the inorganic and/or organic compounds begins, which turns into vapor that expands inside the drying chamber 2. The steam generated is conveyed to the outside of the drying chamber and condensed through the use of a condensate separation device 11 and collected in a container via a drain valve.

The achievement of the desired degree of drying, that is, the percentage of residual moisture in the inorganic and/or organic compounds, is detected by measuring the decrease in weight of the inorganic and/or organic compounds using the load cell system 200. In fact, the decrease in weight measures the amount of evaporated water and, consequently, the decrease in moisture content of the inorganic and/or organic compounds.

A housing can be provided underneath casing 1 to house the electromagnetic wave generator, vacuum pump, and a chiller device to condense moisture.

In one possible embodiment, the percentage of residual water contained in said inorganic and/or organic compounds is between 1% and 20% in weight.

Detection of residual water in inorganic and/or organic compounds is carried out on the basis of thermogravimetric analysis, e.g., performed with a thermobalance or moisture meter, e.g., with instruments identified by the KERN® brand and supplied by the German manufacturer KERN & SOHN GmbH.

The drying modes described so far are generally applied to a static or discontinuous type of drying system, for example, as illustrated in the embodiments in FIGS. 4 and 5.

In a possible further embodiment, the same drying modes as described above (modes 1 to 4) can also be applied to a continuous drying system, as shown in FIGS. 5A-5C , wherein a drying chamber 102 is a modular drying chamber, made by connecting in series at least two drying chambers 2 as described above.

Drying chambers 2 are connected in a modular fashion to each other in series by means of vacuum-tight flanges to make a single drying chamber 102 with a volume large enough to accommodate a single-or multi-level automatic belt or frame handling system 112, in which frames 112 run through the individual modules 2 passing through special slits 113 made between each module, as shown in FIG. 5B.

The slits 113 are preferably of such a size that the electromagnetic waves generated in each individual module are prevented from exiting, allowing in one possible embodiment to have each individual module 2 work independently of the other modules and thus apply different frequencies to each individual module, which do not interfere with each other.

Such a single drying chamber 102 is equipped with a loading system 103 and an unloading system 104 for the product via respective automatic vacuum-tight rotary valves 103′, 104′ that feed or unload the product onto the belts or frames in the loading or unloading chamber.

The single drying chamber 102 is equipped with an automatic vacuum creation system 120 comprising means for pressure regulation 9, 10, 12. In such possible embodiment each module is equipped with one or more propagation elements 3 and/or electrodes 2, 4 as previously described.

Preferably, the apparatus according to the present invention comprises a drying chamber 102 made by means of a plurality of drying chambers 2 connected to each other in series, and operable individually (e.g., only some of the drying chambers 2 present in the drying chamber 102) or simultaneously (e. g, all the drying chambers 2 present in the drying chamber 102) where preferably, in each case, both when they are operable individually and when they are operable simultaneously, each drying chamber 2 is set and programmed to operate with different or the same parameters than those of another drying chamber 2 within the drying chamber 102; where preferably an automatic belt or frame handling system 112, run through said serially connected drying chambers 2 passing through respective slits made between adjacent drying chambers 2.

FIG. 5D illustrates an embodiment relating to an automatic, continuously operating drying system comprising a plurality of drying chambers, operable individually or simultaneously, and at least one frame 51 or, preferably, a plurality of frames, in which a frame handling system is configured to move the frames and feed the drying chambers, equipped with means for regulating the pressure P, with a certain amount of product to be dried, and for withdrawing the dried product from the drying chambers, wherein each module is equipped with one or more electromagnetic wave propagation elements, preferably arranged along one and the same surface of the drying chamber.

The product to be dried is placed in a 51 frame, which has the appropriate dimensions to hold the desired amount of product based on the specific weight of the product and the desired production capacity. The dimensions of the frame range, for example, from 500 mm per side to 3500 mm per side. The frame can also be rectangular in shape. From the frame accumulator 52 the frame 51 passes into the product loading area 53. From there, it is evenly distributed across the entire surface of the frame via the distributor rollers 53A. Next, frame 51 passes to the elevator feed zone 54 (passage zone), from which it enters an entry zone 54A to the ascending elevator 55 and, once inside the ascending elevator 55, a sensor system (not shown in the figure) signals that the frame is in position. Next, frame pickup system 56 picks up frame 51 and lifts it to the height of drying chamber 57, which is ready to receive frame 51 and signaled via PLC by special sensors (not shown in the figure) designed to select the nearest empty drying chamber ready to receive frame 51, to begin the drying phase. Generator(s) 58 of electromagnetic waves are similar to those described above and are installed integral to a surface of the drying chamber. Once the frame is positioned in the correct position, determined by means of other appropriate sensors (not shown in the figure), the top of the drying chamber descends onto the frame by means of a piston 59 and together with it forms a watertight parallelepiped-shaped cavity, where a vacuum is created by means of pump P and electrovalve P1. The vacuum is maintained at a predetermined pressure by means of the pressure switch RV that controls the air inlet and air drain valve A1, which is connected to the suction and drain system A. The product is subjected to a field of electromagnetic waves introduced through appropriate waveguides. After drying is complete, the top of the cavity is raised, via piston 59, and the frame moves to the descending elevator zone 511, where it is picked up by the unloading device 510 and controlled by the PLC via appropriate positioning sensors and then descended via the descending elevator 511 and then moved to the tipping zone 512, where, via a piston (not shown in the figure), the frame is lifted sideways. In this way the dry product slides onto a conveyor belt (not shown in the figure) for subsequent processing steps. From here the frame passes to the frame down zone 513 and via the frame return device 514 returns to the beginning of the line to start a new cycle again.

### Application Example 1:

In relation to plant products such as fruits and vegetables, where it is necessary to preserve the nutritional and organoleptic characteristics of the products, by means of the apparatus of the present invention it is possible to establish a drying diagram that brings the vacuum level to very low pressures (e.g., to 30 mbar at which water evaporates at 24.1°) in such a way as to ensure that the product never exceeds this temperature, rather that it is cooled by the actual evaporation of the water that is known to absorb heat.

In addition, a stabilization time can be established in which no energy is supplied for a few minutes despite the system remaining in a vacuum, so that the moisture within the product is redistributed evenly facilitating the drying process when energy application is resumed.

In the specific case of apples, for example, it was found that by applying a vacuum degree of 30mbar and a heating period of 20 minutes and pause of 3 minutes, it was possible to dry the product in 3.5 hours with a perfect uniformity of final product moisture of 11-12% and keeping intact both the visual (color) and olfactory and taste characteristics, while also stopping the typical oxidative processes characteristic of the apple product in contact with air. In contrast, drying time with traditional air drying systems varies between 24 and 36 hours.

### Application Example 2:

In relation to inorganic products, such as cementitious or brick products may be, it has been observed that the most effective and rapid method of carrying out effective drying, being products that withstand high temperatures sufficiently well, is to heat the product to pressures close to atmospheric pressure (about 500 mbar) and then abruptly reduce the pressure to very low values (around 20 Mbar). At this stage there is a sudden evaporation of water, and a large amount of water is expelled from the product itself and sucked out through the vacuum system. For example, for a clay floor brick using the pulsating vacuum system, starting from a pressure of 500 mbar where the product reached a temperature of 81 degrees maintaining this temperature for 5 minutes and then bringing it to a pressure of 20 mbar for the next 10 minutes and continuing this type of cycle it was possible, with the apparatus of the present invention, to dry the product in about 4 hours instead of the 7 days required with traditional methods.

1. Apparatus for reducing the water content present in inorganic and/or organic compounds of plant or animal origin, comprising
a casing (1) made watertight, defining or within which a drying chamber (2) is defined,
means of pressure regulation (9, 10, 12) suitable for adjusting the pressure value inside said drying chamber (2) in such a way that said pressure value is kept below the value of atmospheric pressure,
heating means (5 and/or 6) for heating said inorganic and/or organic compounds in said drying chamber (2), comprising at least a first generator (5) of electromagnetic waves with at least a first frequency (f1) and/or at least a second generator (6) of electromagnetic waves with at least a second frequency (f2) lower than said first frequency (f1),
where said apparatus further comprises
at least one propagation element (3) for propagating said electromagnetic waves with said at least one first frequency (f1) in said drying chamber (2), connected to said first generator (5) of electromagnetic waves with said at least one first frequency (f1),
and/or at least one pair of electrodes (4, 2) for propagating said electromagnetic waves with said at least one second frequency (f2) in said drying chamber (2), where a first electrode (4) is connected to said second generator (6) of electromagnetic waves with said at least one second frequency (f2) and the second electrode (2) is connected to ground.

2. Apparatus according to claim 1, wherein said pressure regulating means (9, 10, 12) are operated to adjust the pressure value within said drying chamber (2) in such a manner that the pressure is maintained at a constant value during the drying operation, or in such a manner that the pressure assumes a value varying between at least a minimum pressure value and at least a maximum pressure value during the duration of the drying operation.

3. Apparatus according to claim 1, wherein the dimensions of said drying chamber (2) are defined as a function of the wavelength of electromagnetic waves generated by said generators (5 and/or 6), 43 mm per side and 4000 mm per side, or with sides of different size identified within the range between 43 mm and 4000 mm.

4. Apparatus according to claim 1, wherein said drying chamber (2) is cylindrical in shape and whose dimensions are defined as a function of the wavelength of the electromagnetic waves generated by said generators (5 and/or 6), said drying chamber (2) having a diameter between 43 mm and 4000 mm.

5. Apparatus according to claim 1, wherein said drying chamber (2) comprises at least one wall made of microperforated material.

6. Apparatus according to claim 1, comprising a plurality of propagation elements (3) for propagating said electromagnetic waves with said first frequency (f1) in said drying chamber (2), arranged on at least one surface of said drying chamber (2).

7. Apparatus according to claim 6, wherein said propagating elements (3) are arranged at said surface of said drying chamber (2) according to a pattern comprising a first set of propagating elements (3′), and a second set of propagating elements (3″), wherein said first and said second sets of propagating elements (3′, 3″) are parallel with respect to each other, and the propagation elements (3″) of said second set are in a staggered position with respect to the propagation elements (3′) of said first set wherein said propagation elements simultaneously emit the same frequency in phase, or the same frequency in a staggered mode.

8. Apparatus according to claim 1, wherein said pressure regulating means (9, 10, 12) comprises at least one regulating valve (9) to deliver air from the environment to the interior of said drying chamber (2), and at least one vacuum pump (12) to draw fluids from said drying chamber (2) to the exterior environment to put it under vacuum.

9. Apparatus according to claim 1, wherein said first generator (5) of electromagnetic waves with said at least one first frequency (f1) comprises a generator of high frequency electromagnetic wave with at least one frequency (f1) between 900 MHz and 3000 MHz.

10. Apparatus according to claim 1, wherein said second generator (6) of electromagnetic waves with said at least one second frequency (f2) comprises a generator of low frequency electromagnetic wave with at least one frequency (f2) between 10 MHz and 920 MHz.

11. Apparatus according to claim 1 that comprises a control logic unit (13), connected at least to said means of pressure regulation (9, 10, 12) and at least to said generators (5 and/or 6) of electromagnetic waves.

12. Apparatus according to claim 1, wherein said second ground-connected electrode (2) comprises the surface of said drying chamber (2).

13. Apparatus according to claim 1, comprising a first filter (7) for preventing the passage of electromagnetic waves having a frequency lower than said first frequency (f1), from said drying chamber (2) to said first generator (5) of electromagnetic waves with said first frequency (f1).

14. Apparatus according to claim 1, comprising a second filter (8) for preventing the passage of electromagnetic waves having a frequency higher than said second frequency (f2), from said drying chamber (2) to said second generator (6) of electromagnetic waves with said second frequency (f2).

15. Apparatus according to claim 1, wherein said at least one propagation element (3) for propagating said electromagnetic waves with said first frequency (f1) in said drying chamber (2) comprises a waveguide and/or a connector/antenna system.

16. Apparatus according to claim 1, wherein said drying chamber (2) comprises at least one support element (2′) made of a material transparent to electromagnetic waves generated by said electromagnetic wave generators (5 and/or 6).

17. Apparatus according to claim 1, comprising a drying chamber (102) made by means of a plurality of drying chambers (2) connected to each other in series, and operable individually or simultaneously, wherein an automatic belt or frame handling system (112), run through said drying chambers (2) connected in series passing through respective slits made between adjacent drying chambers (2).

18. Apparatus according to claim 1, comprising a plurality of drying chambers (2), operable individually or simultaneously, wherein a frame handling system is configured to feed said drying chambers (2) with an amount of product to be dried, and to withdraw from said drying chambers (2) a quantity of dried product.

19. Apparatus according to claim 18, wherein the frame handling system is configured to handle at least one frame (51) to feed said drying chambers (2) with said amount of product to be dried and to withdraw from said drying chambers (2) said amount of dried product.

20. Apparatus according to claim 19, in which the frame handling system is configured to handle a plurality of frames (51).

21. Method for reducing the water content present in inorganic and/or organic compounds of plant or animal origin by an apparatus according to claim 1, comprising the following steps:
(a) introducing the inorganic and/or organic compounds to be dried into said drying chamber (2);
(b) heating said inorganic and/or organic compounds to a temperature that causes evaporation of water contained in said inorganic and/or organic compounds;
(c) maintaining said temperature until the amount of water contained in said inorganic and/or organic compounds is reduced to a predetermined value;
(d) extracting the evaporated water from said drying chamber (2);
(e) extracting the dried inorganic and/or organic compounds from the drying chamber (2), characterized by the fact that said step (b) of heating inorganic and/or organic compounds comprises the following steps:
(b1) operating said means of pressure regulation (9, 10, 12) to adjust the pressure so that the pressure value inside said drying chamber (2) is kept below the value of atmospheric pressure throughout the duration of the drying operation;
(b2) operating said at least one first generator (5) of electromagnetic waves with at least a first frequency (f1) and/or said at least one second generator (6) of electromagnetic waves with at least a second frequency (f2), lower than said first frequency (f1), to generate electromagnetic waves within said drying chamber (2) that invest said inorganic and/or organic compounds,
wherein the pressure value within said drying chamber (2) is selected so that evaporation of water contained in inorganic and/or organic compounds occurs at a drying temperature between −40° C. to +99.8° C., and wherein
said at least one first generator (5) of electromagnetic waves with said at least one first frequency (f1) generates high-frequency electromagnetic waves with at least one frequency (f1) between 900 MHZ and 3000 MHz, and/or said at least one second generator (6) of electromagnetic waves with said at least one second frequency (f2) generates low-frequency electromagnetic waves with at least one frequency (f2) between 10 MHz and 920 MHz.

22. Method according to claim 21, wherein said at least one first generator (5) of electromagnetic waves with said at least one first frequency (f1) and/or said at least one second generator (6) of electromagnetic waves with said at least one second frequency (f2) may be individually present in the apparatus according to claim 1.

23. Method according to claim 21, wherein said at least one first generator (5) of electromagnetic waves with said at least one first frequency (f1) and said at least one second generator (6) of electromagnetic waves with said at least one second frequency (f2) are operated alternately.

24. Method according to claim 21, wherein said at least one first generator (5) of electromagnetic waves with said at least one first frequency (f1) and said at least one second generator (6) of electromagnetic waves with said at least one second frequency (f2) are operated simultaneously.

25. Method according to claim 21, wherein said generators (5 and/or 6) are configured to continuously vary the frequency and/or phase shift of electromagnetic waves.

26. Method according to claim 21, wherein said pressure value within said drying chamber (2) is between 0.01 mbar and 999 mbar.

27. Method according to claim 21, wherein in said step (b1) said pressure regulating means (9, 10, 12) are operated to maintain the pressure within said drying chamber (2) at a constant value throughout the duration of the drying operation.

28. Method according to claim 21, wherein in said step (b1) said pressure regulating means (9, 10, 12) are operated to vary the pressure within said drying chamber (2) between at least a minimum pressure value and at least a maximum pressure value throughout the duration of the drying operation.

29. Method according to claim 28, wherein said minimum pressure value is about 1 mbar, and said maximum pressure value is about 200 mbar.

30. Method according to claim 21, which subsequent to said step (d) of extracting evaporated water from said drying chamber (2) further comprises a step of condensing evaporated water from said inorganic and/or organic compounds by means of a condensate separator element (11).

31. Method according to claim 21, wherein the step of introducing the inorganic and/or organic compounds to be dried into said drying chamber (2) comprises the step of moving said at least one frame (51) configured to feed said drying chamber (2) with an amount of product to be dried, and wherein the step of extracting the dried inorganic and/or organic compounds from said drying chamber (2) comprises the step of withdraw said at least one frame (51) with an amount of dried product.

32. Method according to claim 31, comprising the step of moving a plurality of frames (51).

33. (canceled)
